(19) United States
(12) Patent Application Publication
(10) Pub. No.: US 2014/0175684 A1
(43) Pub. Date: Jun. 26, 2014

(54) Methods and Equipment for Trimming Polarizers in Displays

(71) Applicant: APPLE INC., CUPERTINO, CA (US)

(72) Inventor: Mohd Fadzli A. Hassan, San Francisco, CA (US)

(73) Assignee: APPLE INC., CUPERTINO, CA (US)

(21) Appl. No.: 13/723,130

(22) Filed: Dec. 20, 2012

(51) Int. Cl. B29D 11/00

(52) U.S. Cl. CPC B29D 11/00644
USPC 264/1.34; 425/174.4

(57) ABSTRACT

An electronic device is provided with a display such as a liquid crystal display mounted in an electronic device housing. The display includes a glass display layer such as a glass color filter substrate. A polarizer layer is formed on the glass display layer. To ensure that the peripheral edge of the polarizer layer matches the peripheral edge of the glass display layer, a laser beam scanning system is used to trim edge portions of the polarizer layer that overhang the glass display layer. The laser beam scanning system includes a moving laser beam that makes multiple scans along the edge of the polarizer layer. To prevent damage to the glass display layer during trimming operations, a characteristic of the moving laser is modified in between successive scans such that the energy density of the laser cut is reduced as the laser beam approaches the surface of the glass.

### BACKGROUND

This relates generally to electronic devices and, more particularly, to electronic devices with displays.

Electronic devices often include displays. For example, cellular telephones and portable computers often include displays for presenting information to a user.

Displays such as liquid crystal displays have polarizers. The polarizers are formed from polymer layers that are laminated to glass display layers. It may be desirable to ensure that a polarizer layer has the same size as an associated glass display layer. If the polarizer is too large, the edge of the polarizer will overhang the edge of the glass display layer, which in turn could lead to polarizer peeling. If the polarizer is too small, the edge of the display will have an unsightly visible polarizer edge. Although the polarizer edge may be covered with a plastic bezel, the use of a bezel reduces the visible area of a display and can make the display unattractive.

It would therefore be desirable to be able to provide improved displays with polarizers for electronic devices.

### SUMMARY

An electronic device is provided with a display such as a liquid crystal display mounted in an electronic device housing. The display has a layer of liquid crystal material sandwiched between an upper display layer such as a color filter layer and a lower display layer such as a thin-film-transistor layer.

An upper polarizer is formed on the upper surface of the color filter layer. A lower polarizer is formed on the lower surface of the thin-film-transistor layer. Additional display structures provide backlight for the display.

The color filter layer includes a glass substrate to which the upper polarizer is laminated. The polarizer initially has excess portions that overhang the glass substrate. A laser beam scanning system is used to trim edge portions of the polarizer that overhang the glass substrate.

The laser beam scanning system includes a moving laser beam that makes multiple scans along the edge of the polarizer layer. To ensure that the glass substrate is not damaged during polarizer trimming operations, a characteristic of the moving laser beam is modified in between successive scans as the laser beam approaches the surface of the glass substrate. For example, the energy density of the laser cut is reduced as the laser beam approaches the surface of the glass substrate.

The energy density of a laser cut can be reduced by increasing the spot size of the moving laser beam. Other laser characteristics such as optical power output and laser light wavelength can be adjusted to reduce the energy density of the laser cut as each successive scan cuts closer to the surface of the glass substrate.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with display structures in accordance with an embodiment.

FIG. 2 is a perspective view of an illustrative electronic device such as a handheld electronic device with display structures in accordance with an embodiment.

FIG. 3 is a perspective view of an illustrative electronic device such as a tablet computer with display structures in accordance with an embodiment.

FIG. 4 is a perspective view of an illustrative electronic device such as a computer display with display structures in accordance with an embodiment.

FIG. 5 a cross-sectional side view of an illustrative display of the type that may be used in devices of the types shown in FIGS. 1, 2, 3, and 4 in accordance with an embodiment.

FIG. 6 is a cross-sectional side view of an illustrative polarizer layer in accordance with an embodiment.

FIG. 7 is a diagram of an illustrative system being used to form a display layer such as a glass substrate layer for a liquid crystal display color filter layer in accordance with an embodiment.

FIG. 8 is a diagram of an illustrative system being used to laminate a polarizer to a display layer in accordance with an embodiment.

FIG. 9 is diagram of an illustrative system in which laser-based equipment is being used to trim a polarizer on a display layer in accordance with an embodiment.

FIG. 10A is a side view of an illustrative focusing lens and focused laser beam of the type used in initial polarizer trimming operations using the equipment of FIG. 9 in accordance with an embodiment.

FIG. 10B is a side view of an illustrative focusing lens and focused laser beam of the type used in final polarizer trimming operations using the equipment of FIG. 9 in accordance with an embodiment.

FIG. 11 is a diagram illustrating how a moving laser beam makes multiple scans to remove edge portions of a polarizer layer in accordance with an embodiment.

FIG. 12 is a graph showing the respective absorption spectra of a polarizer film and a glass substrate in accordance with an embodiment.

FIG. 13 is a flow chart of illustrative steps involved in forming electronic devices and displays by trimming polarizers on glass display layers in accordance with an embodiment.

### DETAILED DESCRIPTION

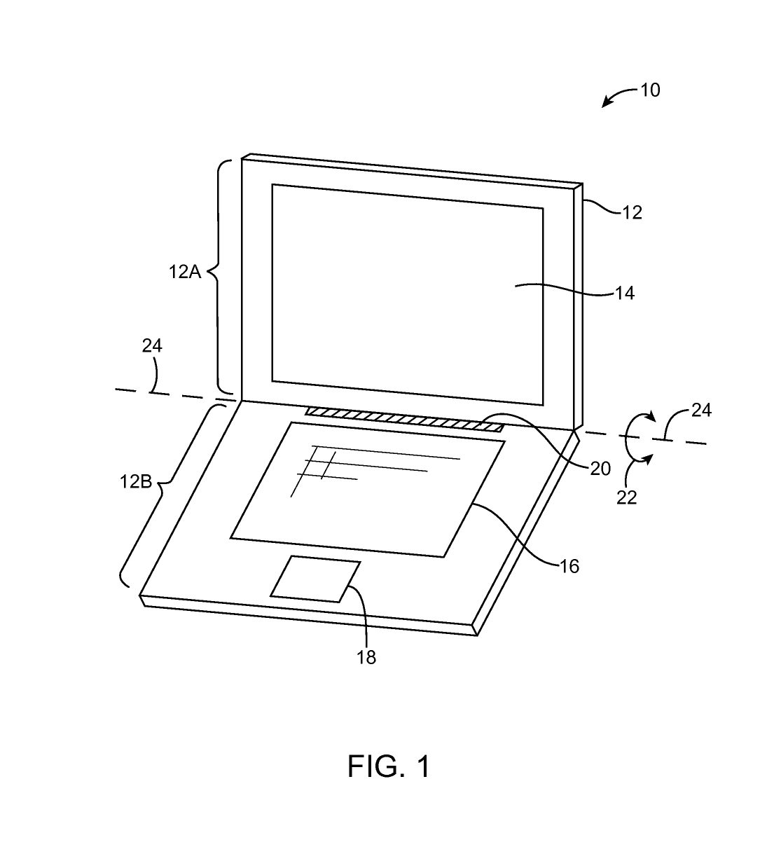

Displays in electronic devices such as liquid crystal displays may be provided with polarizers. Illustrative electronic devices that have displays with polarizers are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 to allow upper housing 12A to rotate in directions 22 about rotational axis 24 relative to lower housing 12B. Display 14 is mounted in upper housing 12A. Upper housing 12A, which may sometimes referred to as a display housing or lid, is placed in a closed position by rotating upper housing 12A towards lower housing 12B about rotational axis 24.

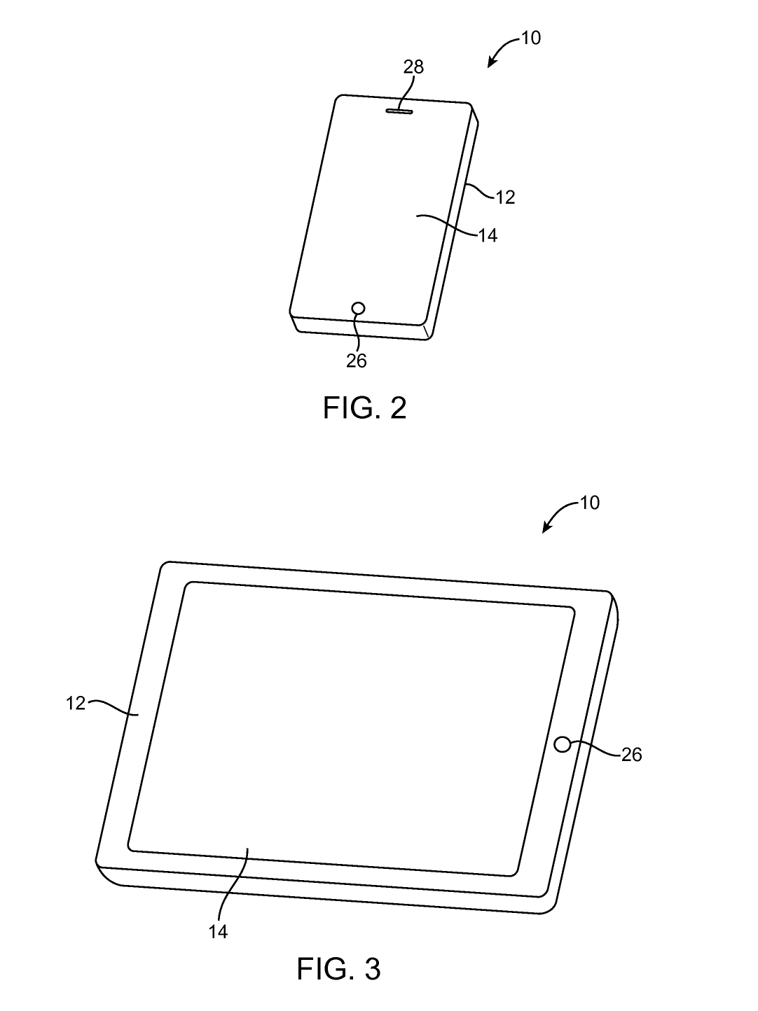

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

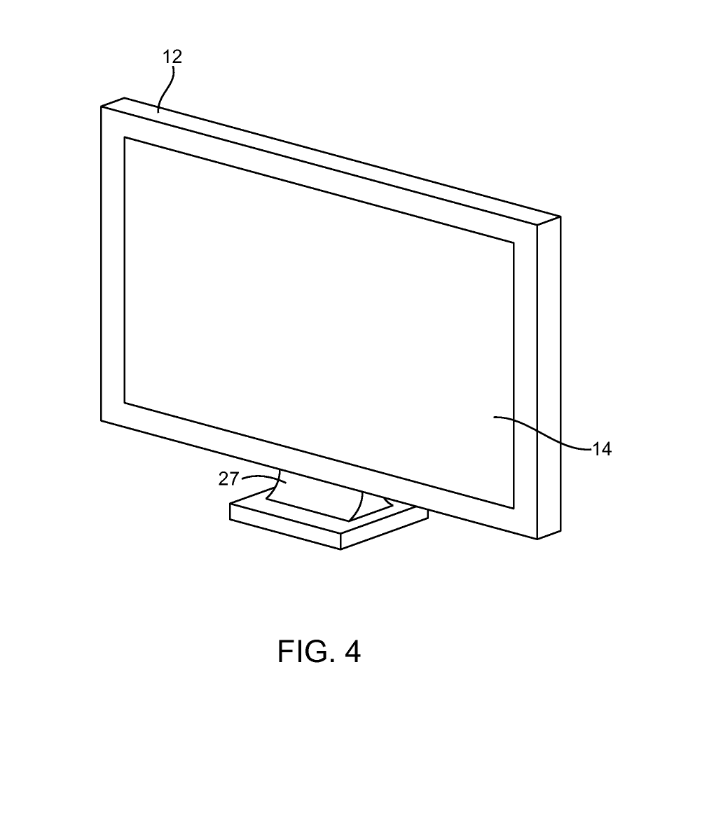

FIG. 4 shows an illustrative configuration for electronic device 10 in which device 10 is a computer display or a computer that has been integrated into a computer display. With this type of arrangement, housing 12 for device 10 is mounted on a support structure such as stand 27. Display 14 is mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

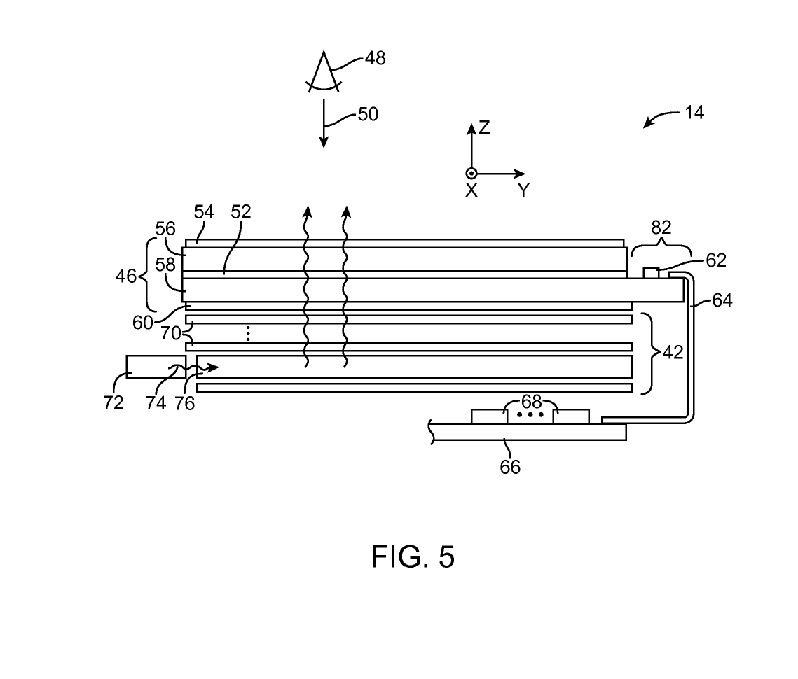

A cross-sectional side view of an illustrative configuration for display 14 of device 10 (e.g., for display 14 of the devices of FIG. 1, FIG. 2, FIG. 3, FIG. 4 or other suitable electronic devices) is shown in FIG. 5. As shown in FIG. 5, display 14 includes backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 illuminates images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 form a liquid crystal display or may be used in forming displays of other types.

In a configuration in which display layers 46 are used in forming a liquid crystal display, display layers 46 include a liquid crystal layer such a liquid crystal layer 52. Liquid crystal layer 52 is sandwiched between display layers such as display layers 58 and 56. Layers 56 and 58 are interposed between lower polarizer layer 60 and upper polarizer layer 54.

Layers 58 and 56 are formed from transparent substrate layers such as clear layers of glass or plastic. Layers 56 and 58 are layers such as a thin-film transistor layer (e.g., a thin-film-transistor substrate such as a glass layer coated with a layer of thin-film transistor circuitry) and/or a color filter layer (e.g., a color filter layer substrate such as a layer of glass having a layer of color filter elements such as red, blue, and green color filter elements arranged in an array). Conductive traces, color filter elements, transistors, and other circuits and structures are formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 is a thin-film transistor layer that includes an array of thin-film transistors and associated electrodes (display pixel electrodes) for applying electric fields to liquid crystal layer 52 and thereby displaying images on display 14. Layer 56 is a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits such as components 68 on printed circuit 66 of FIG. 5 and/or other circuitry) is used to generate information to be displayed on display 14 (e.g., display data). The information to be displayed is conveyed from circuitry 68 to display driver integrated circuit 62 using a signal path such as a signal path formed from conductive metal traces in flexible printed circuit 64 (as an example).

Display driver circuitry such as display driver integrated circuit 62 of FIG. 5 is mounted on thin-film-transistor layer driver ledge 82 or elsewhere in device 10. A flexible printed circuit cable such as flexible printed circuit 64 is used in routing signals between printed circuit 66 and thin-film-transistor layer 58. If desired, display driver integrated circuit 62 may be mounted on printed circuit 66 or flexible printed circuit 64. Printed circuit 66 is formed from a rigid printed circuit board (e.g., a layer of fiberglass-filled epoxy) or a flexible printed circuit (e.g., a flexible sheet of polyimide or other flexible polymer layer).

Backlight structures 42 include a light guide plate such as light guide plate 78. Light guide plate 78 is formed from a transparent material such as clear glass or plastic. During operation of backlight structures 42, a light source such as light source 72 generates light 74. Light source 72 may be, for example, an array of light-emitting diodes.

Light 74 from one or more light sources such as light source 72 is coupled into one or more corresponding edge surfaces such as edge surface 76 of light guide plate 78 and is distributed in dimensions X and Y throughout light guide plate 78 due to the principal of total internal reflection. Light guide plate 78 includes light-scattering features such as pits or bumps. The light-scattering features are located on an upper surface and/or on an opposing lower surface of light guide plate 78.

Light 74 that scatters upwards in direction Z from light guide plate 78 serves as backlight 44 for display 14. Light 74 that scatters downwards is reflected back in the upwards direction by reflector 80. Reflector 80 is formed from a reflective material such as a layer of white plastic or other shiny materials.

To enhance backlight performance for backlight structures 42, backlight structures 42 include optical films 70. Optical films 70 include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 overlap the other structures in backlight unit 42 such as light guide plate 78 and reflector 80. For example, if light guide plate 78 has a rectangular footprint in the X-Y plane of FIG. 5, optical films 70 and reflector 80 preferably have a matching rectangular footprint.

The outermost layer of display 14 may be a protective display layer such as a layer of glass that covers layers 46 or a display layer such as color filter layer 56 (e.g., a glass substrate layer in layer 56) may serve as the outermost structural layer in display 14. Visible border structures in display 14 can be minimized by accurately trimming polarizer 54 along the edge of layer 56. Polarizing trimming operations can be performed using lasers, cutting blades (knife edges), or other trimming equipment. Care should be taken during trimming operations not to damage display layer 56. As an example, care should be taken not to induce thermal damage to a glass substrate in layer 56 during laser trimming operations or mechanical damage to a glass substrate in layer 56 during cutting blade trimming operations.

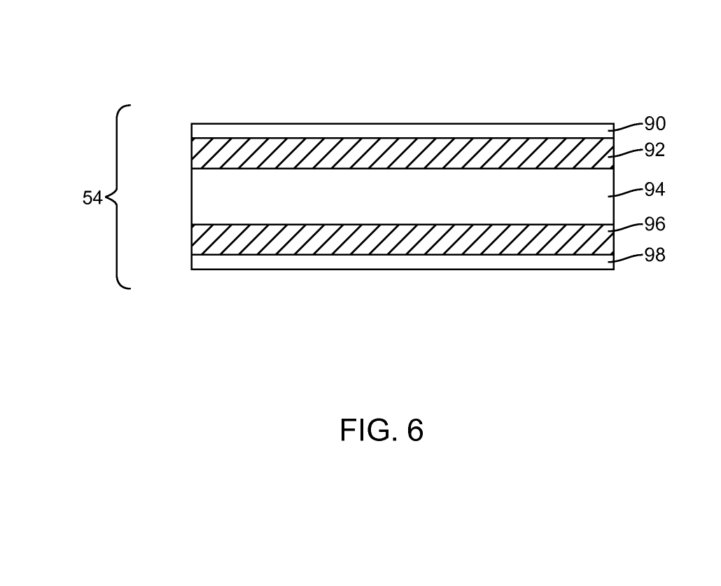

A cross-sectional side view of an illustrative polarizer layer in display 14 is shown in FIG. 6. Polarizer layer 54 of FIG. 6 is an upper polarizer such as upper polarizer 54 of FIG. 5. Lower polarizer layers such as lower polarizer 60 may be constructed similarly.

In the example of FIG. 6, polarizer 54 is formed from multiple layers of material that are attached together. Polarizer film 94 is formed from a stretched polymer such as stretched polyvinyl alcohol (PVA) and may therefore sometimes be referred to as a PVA layer. Iodine may be placed on the stretched PVA film so that iodine molecules align with the stretched film and form the polarizer. Other types of polarizer films may be used if desired.

Polarizer film 94 is sandwiched between layers 92 and 96. Layers 92 and 96 may be formed from a material such as tri-acetyl cellulose (TAC) and may sometimes be referred to as TAC films or may be formed from other polymers. The TAC films may help hold the PVA film in its stretched configuration and may protect the PVA film. Other films may be attached to polarizer film 94 if desired.

Coating layer 90 includes one or more films of material that provide polarizer 54 with desired surface properties. For example, layer 90 may be formed from materials that provide polarizer 54 with antiglare (light diffusing) properties, antireflection properties, scratch resistance, fingerprint resistance, and other desired properties. Layer 90 preferably is formed from one or more layers of material such as antireflection (AR) layers (e.g., films formed from a stack of alternating high-index-of-refraction and low-index-of-refraction layers), antiglare layers, antireflection-antiglare layers, oleophobic layers, antiscratch coatings, and other coating layers. The functions of these layers need not be mutually exclusive. For example, an antiglare film in coating 90 may help provide polarizer 54 with scratch resistance.

Polarizer 54 can be provided with a layer of adhesive such as adhesive layer 98 to help attach polarizer 54 to the upper surface of display layers 46 (i.e., color filter 56 of FIG. 5). The thickness of polarizer 54 may be about 50-200 microns or 90-180 microns (as examples). During manufacturing operations, adhesive 98 attaches polarizer 54 to the upper surface of color filter layer 56.

Trimming operations are preferably used to trim the edge of polarizer 54 to match the edge of color filter layer 56.

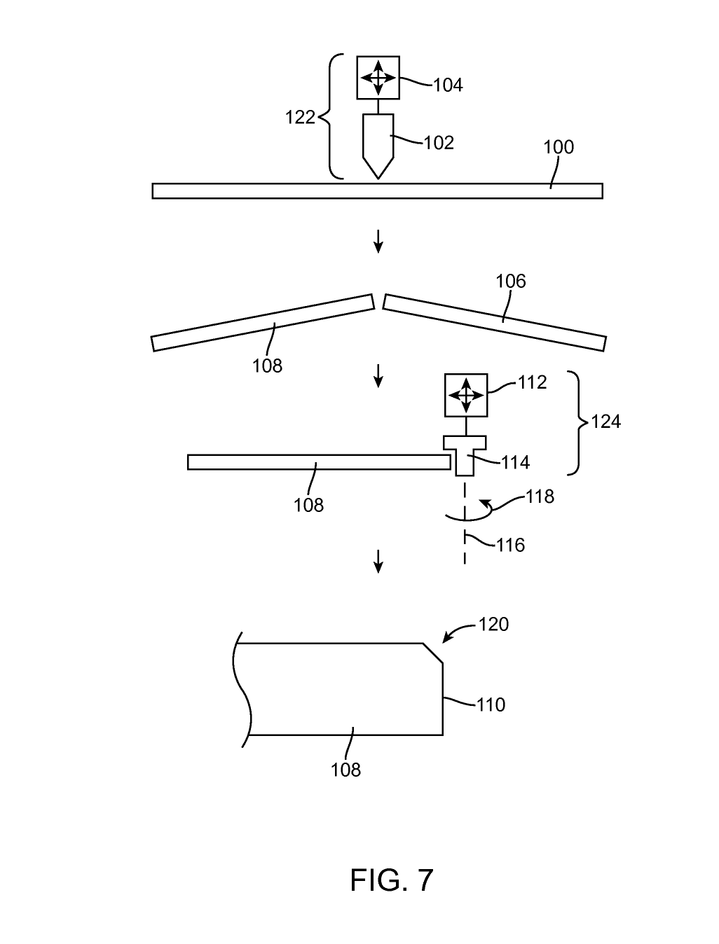

As shown in FIG. 7, color filter substrates such as substrate 108 can be formed from larger sheets of material such as layer 100. Layer 100 may be a layer of glass, a ceramic layer, a polymer layer, or other suitable display layer substrate. As an example, layer 100 may be a glass layer.

Initially, glass layer 100 will be oversized (i.e., layer 100 will be larger than needed for forming display 14). Equipment such as equipment 122 is used to divide layer 100 into smaller pieces such as substrate 108. Equipment 122 may be substrate cutting equipment such as water-jet cutting equipment, laser cutting equipment, sawing equipment, machining equipment, or other equipment for dividing layer 100 into smaller pieces. In the illustrative configuration of FIG. 7, equipment 122 includes a computer-controlled positioner such as positioner 104 and a scribing tool such as scribing tool 102. Positioner 104 moves scribing tool 102 in a desired pattern over the surface of layer 100 to form scribe lines. Manual and/or automated equipment may then be used to break layer 100 along the scribe lines to form separate pieces of layer 100 such as pieces 106 and 108. Pieces 106 and 108 have the size and shape of display 14 (e.g., a rectangular display-sized piece of glass).

Following the use of scribing operations or other operations to separate out individual glass layers such as display-sized glass layer 108 from glass layer 100 using equipment 122, machining equipment 124 or other edge treatment equipment is used to modify edge surface 100 of the peripheral edge of glass layer 108. In the illustrative configuration of FIG. 7, equipment 124 includes computer-controlled positioner 112 and machining tool head 114. Head 114 has a surface profile that is configured to ease the sharp corners in layer 108 (e.g., by rounding the upper and lower edges of layer 108, by beveling the upper and lower edges of layer 108, etc.).

During operation, positioner 112 rotates machining tool head 114 about rotational axis 116 in direction 118 while moving head 114 along the edge of layer 108, thereby machining edge surface 110 of layer 108 into a desired shape. As shown at the bottom of FIG. 7, equipment 124 can provide layer 108 with a machined profile for surface 110 such as an edge profile that includes one or more bevels such as bevel 120.

Machined glass layer 108 is used as a substrate for one or more layers in display 14. For example, layer 108 may serve as a color filter layer substrate for color filter layer 56 or other display layer in display 14. If desired, substrate layer 108 may be formed form plastic, ceramic, or other transparent materials. The use of clear glass for forming layer 108 is merely illustrative.

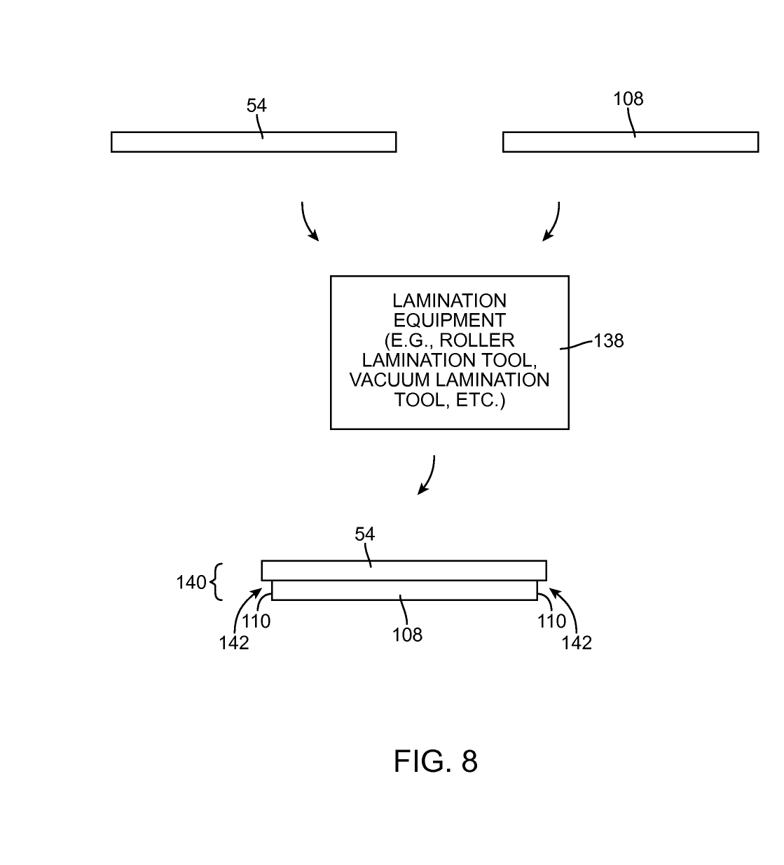

FIG. 8 is a system diagram showing how polarizer 54 may be attached to substrate layer 108. In the illustrative configuration of FIG. 8, lamination equipment 138 is being used to laminate polarizer 54 to substrate layer 108. Lamination equipment 138 may include a roller laminator, vacuum lamination equipment, or other equipment for attaching polarizer 54 to substrate 108. When attached using roller-based lamination equipment or other lamination equipment, adhesive layer 98 attaches the lower surface of polarizer 54 to the upper surface of display layer 108 to form display structures 140, as shown in the bottom of FIG. 8.

In display structures 140, polarizer 54 has larger lateral dimensions than the corresponding lateral dimensions of substrate layer 108. As a result, portions of polarizer layer 54 extend laterally beyond edge 110 of substrate 108 to form overhanging (overlapping) edge portions 142 of layer 54.

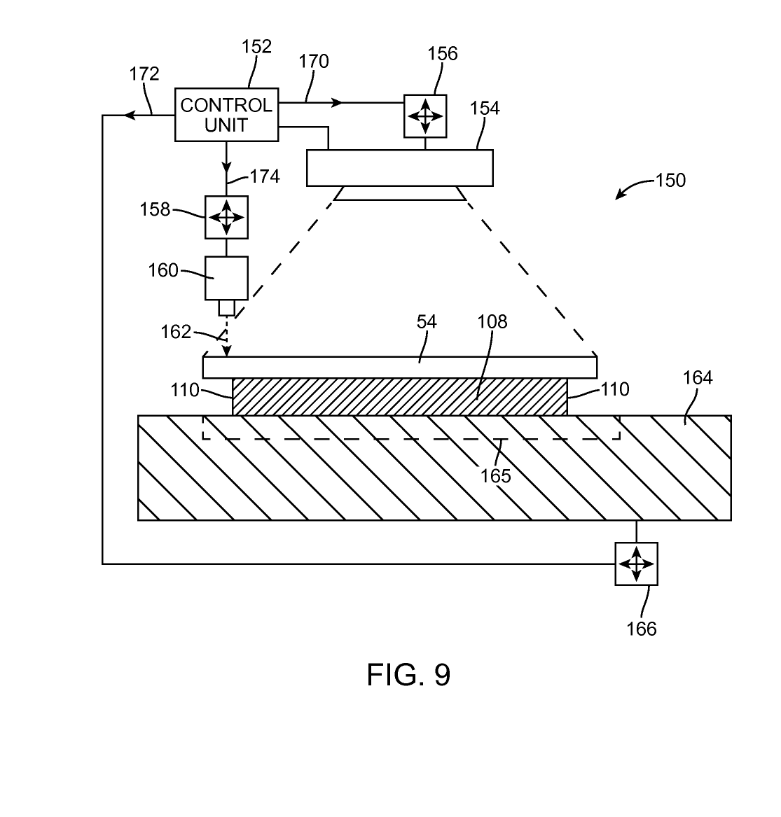

Following attachment of polarizer 54 to the upper surface of glass layer 108, polarizer 54 may be trimmed to remove excess portions such as protruding portions 142. A system such as laser-based trimming system 150 of FIG. 9 or other trimming equipment is used to trim the edges of polarizer 54 following attachment of polarizer 54 to substrate layer 108. In a configuration of the type shown in FIG. 9, system 150 includes a camera such as camera 154 for capturing images of layers 54 and 108. Camera 154 includes a digital image sensor that captures digital image data for processing by control unit 152. Camera 154 preferably has sufficient resolution for capturing images of edge 110. Layers 108 and 54 are supported by support structures 164 during digital imaging operations. Light source 165 in support structures 164 generates polarized and/or unpolarized backlight 167 for illuminating layers 108 and 54. The use of polarized light in illuminating layers 108 and 54 can help delineate the location of edge 110 for camera 154.

Data from camera 154 is analyzed by control unit 152 to determine the position of edge 110 relative to laser 160 and laser beam 162. Control unit 152 may be one or more computers, embedded processors, networked computing equipment, online computing equipment, and/or other computing equipment for processing digital image data from camera 154 or other sensors to determine the location of edges 110 and for issuing corresponding control signals on outputs 170, 172, and 174.

The control signals on outputs 170, 172, and 174 control the operation of computer-controlled positioners 156, 166, and 158, respectively. For example, control commands on path 170 control the operation of positioner 156, which is used in adjusting the position of camera 154. Control signals on path 172 are used in controlling the operation of positioner 166, which is used in adjusting the position of support 164 (and therefore layers 108 and 54) relative to laser beam 162. Control signals on line 174 are used to control positioner 158 and thereby adjust the position of laser 160 and laser beam 162 relative to edge 110. If desired, different arrangements of positioners may be used. As an example, the position of machine vision equipment such as camera 154 may be fixed and/or positioner 158 and/or positioner 166 may be omitted. Additional positioners (e.g. to control mirrors or other optical structures that direct beam 162 onto layer 54) may also be used. The configuration of FIG. 9 is shown as an example.

Care must be taken to provide polarizer layer 54 with the desired cut while also ensuring that substrate 108 is not damaged during polarizer trimming operations. It can be difficult to obtain a flush edge between polarizer layer 54 and substrate 108 without comprising the strength of glass substrate 108. To address this concern, trimming equipment 150 of FIG. 9 and the process steps performed by trimming equipment 150 are optimized to achieve a precise polarizer cut while minimizing thermal and mechanical damage to layer 108.

Laser-based trimming equipment 150 is a laser beam scanning system that makes multiple scans with a moving laser beam along an edge of polarizer 54. Between successive scans, one or more characteristics of the moving laser beam is modified. For example, the energy density of the laser light cut (sometimes referred to as beam exposure) may be decreased as laser beam 162 approaches the surface of layer 108. As the energy density of the laser light cut decreases, control of the laser cut increases.

A polarizer that is being trimmed with a laser beam of power P and beam radius r that is moving along the edge of the polarizer with a scan velocity V is exposed to an energy density approximately equal to E_{ρ} of equation 1.

$${E}_{ρ} = \frac{2 P}{π r V} \qquad ( 1 )$$

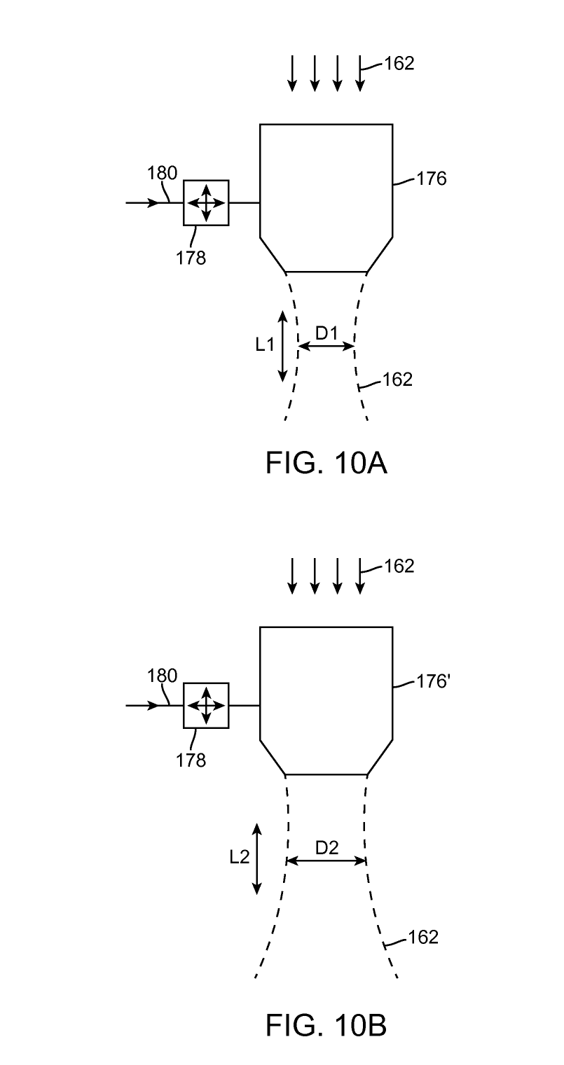

The energy density E_{ρ} (and thus the control of the resulting laser cut) can be manipulated by changing characteristics of the laser. For energy density E_{ρ} can be increased by increasing the laser power, by decreasing the spot size of the laser beam, by decreasing the scanning velocity with which the laser beam scans polarizer 54, and/or by decreasing the beam exposure frequency. Characteristics of laser 160 may be modified by changing laser 160 or by changing the optical structures within laser 160. Illustrative optic structures that may be manipulated to adjust the power density of laser beam 162 (and thus the energy density of the laser cut) are shown in FIG. 10A and FIG. 10B.

As shown in FIG. 10A, optical structures such as lens 176 are used to focus laser beam 162. In the configuration of FIG. 10A, the position of lens 176 is controlled by positioner 178. Positioner 178 is a computer-controlled positioner that receives control signals from control unit 152 via input 180. In response, positioner 178 positions lens 176 and therefore laser beam 162 relative to layer 54 and edge 110 (FIG. 9). As shown in FIG. 10A, lens 176 focuses laser beam 162 to produce a spot of diameter D1 over a length L1. Outside of length L1, laser beam 162 becomes unfocused and is characterized by an enlarged spot size and reduced power density. Diameter D1 is sufficiently small to provide beam 162 with relatively high power density within length L1. Using laser beam scanning system 150 of FIG. 9, focused laser beam 162 of FIG. 10A is scanned along a strip of polarizer 54 during initial trimming operations to trim away excess portions of polarizer 54. Initial trimming operations that use higher energy density laser cuts are sometimes referred to as high-power cuts.

As laser beam 162 of FIG. 10A approaches the surface of substrate 108 with each successive scan, one or more components or settings in system 150 are changed such that the resulting energy density associated with the laser cut is reduced. For example, optical structures such as lens 176 may be modified or replaced to produce a laser beam with a larger spot size and therefore lower power density. Optical structures such as lens 176′ of FIG. 10B are used to focus laser beam 162 during low-power cuts. As shown in FIG. 10B, lens 176′ focuses laser beam 162 to produce a spot of diameter D2 over a length L2. Outside of length L2, laser beam 162 becomes unfocused and is characterized by an enlarged spot size and reduced power density. Diameter D2 is larger than diameter D1 of FIG. 10A and laser beam 162 associated with lens 176′ therefore results in laser cuts having lower energy density than the laser cuts associated with lens 176 of FIG. 10A. Diameter D2 is sufficiently large to make laser cuts with lower energy density so that trimming operations can be controlled with precision.

Using polarizer trimming system 150 of FIG. 9, laser beam 162 of FIG. 10B is applied to polarizer 54 during final trimming operations to trim away excess portions of polarizer 54 and thereby ensure that the lateral dimensions of polarizer 54 in dimensions X and Y match the respective lateral dimensions of glass layer 108 in dimensions X and Y. Final trimming operations that use lower energy density laser cuts are sometimes referred to as low-power cuts. A lower power density laser beam such as laser beam 162 of FIG. 10B is used to achieve a flush edge between polarizer 54 and glass layer 108 without exposing glass layer 108 to excessive laser light that results in heating of layer 108. System 150 can therefore avoid degrading the strength and reliability of layer 108.

Each scan is performed using equipment that is optimized for the particular type of cut being made. The energy density of each laser cut is reduced as laser beam 162 approaches the surface of glass layer 108. For example, the energy density of each laser cut may be reduced as laser beam 162 cuts deeper into polarizer layer 54 (e.g., along the z-axis of FIG. 5). As another example, the energy density of each laser cut may be reduced as laser beam 162 approaches edge 110 of glass layer 108 (e.g., along the x-axis and/or y-axis of FIG. 5). The energy density of the laser cut made with each laser scan may be reduced one, two, three, four, five, or more than five times during the multiple-scan polarizer trimming process.

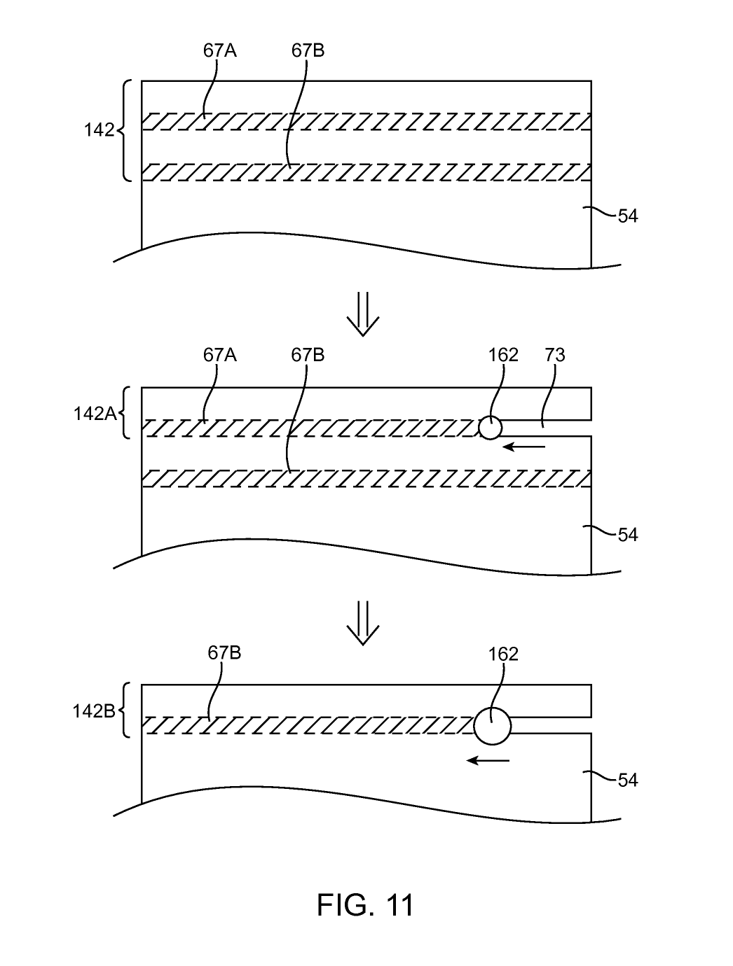

An illustrative diagram showing how multiple scans are used to trim excess portions of polarizer 54 is shown in FIG. 11. As shown in FIG. 11, polarizer 54 has excess edge portions 142 that overhang glass substrate 108. Excess edge portions 142 are removed using laser beam scanning system 150 of FIG. 9. With each scan, a moving laser beam applies energy to strip-shaped portions 67A and 67B of polarizer 54 (sometimes referred to as strips, cuts, paths, cut strips, trim paths, cutting paths, or laser beam receiving portions). During a first scan, laser beam 162 makes a first laser light cut 73 with a first energy density along cutting path 67A to thereby remove edge portion 142A of polarizer 54. During a second scan, laser beam 162 makes a second laser light cut 75 with a second energy density that is less than the first energy density along cutting path 67B to thereby remove edge portion 142B of polarizer 54. Laser beam 162 used during the second scan may, for example, have a larger spot size than laser beam 162 used during the first scan. The spot size of laser beam 162 can be manipulated by modifying the focusing lens structures associated with laser 160. If desired, laser beam scanning system 150 may perform one, two, three, four, five, or more than five scans during the process of trimming edges such as edges 142 of polarizer 54. Characteristics of the moving laser beam can be changed between successive scans.

The example of FIG. 11 in which the energy density of each laser cut is based on a lateral distance to edge 110 of layer 108 is merely illustrative. If desired, the energy density of each laser cut can be based on the vertical distance to the top surface of layer 108.

In addition to or instead of modifying lens structures associated with laser 160, other components and/or settings can be modified to change the power density of laser beam 162 and/or to change the energy density of each laser cut during the multiple-scan polarizer trimming process. Examples of components and settings that may be modified to change the energy density of a laser cut include the optical power output (e.g., the average power output in the case of a pulsed or modulated laser or the continuous power output in the case of a continuous wave laser) of laser 160, the type of laser 160 used in system 150 (e.g., gas laser, solid-state laser, dye laser, semiconductor laser, or other suitable type of laser), the wavelength of light emitted by laser 160 (e.g., wavelengths in the ultraviolet range, wavelengths in the visible range, wavelengths in the infrared range, etc.), the pulse duration and/or pulse frequency of laser 160 (in arrangements where laser 160 is a pulsed laser), the position of laser 160 relative to polarizer 54 and/or substrate 108, the current applied to laser 160, other suitable components and settings, etc.

The specifications of laser 160 such as the wavelength of light emitted by laser 160 and the pulse duration of laser 160 are optimized for cutting polarizer 54 smoothly while minimizing any effect on glass 108. In one suitable arrangement, laser 160 is a pulsed laser with a pulse duration of 1 to 500 femtoseconds, 500 to 1000 femtoseconds, 1 to 500 picoseconds, 500 to 1000 picoseconds, 1 to 500 nanoseconds, 500 to 1000 nanoseconds, 1 to 500 microseconds, 500 to 1000 microseconds or other suitable pulse duration. In one suitable arrangement, laser 160 has a pulse duration of 500 femtoseconds to 200 nanoseconds. A pulsed laser with short pulse duration results in a high peak power and relatively low pulse energy. Using a laser of this type with high peak power to trim polarizer 54 results in a clean cut along the polarizer edge. Other suitable types of lasers such as continuous wave lasers can be used if desired.

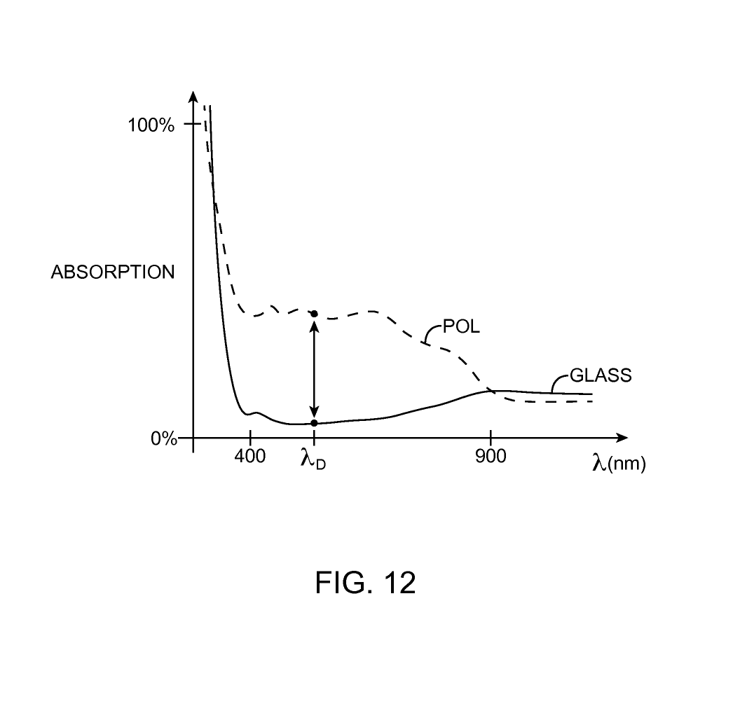

To ensure that laser 160 effectively cuts polarizer 54 without damaging glass layer 108, the wavelength of light emitted by laser 160 is within a range of wavelengths that are absorbed more by polarizer 54 than by glass 108. A graph showing the respective absorption spectra of a polarizer film such as polarizer film 54 (labeled “POL”) and a glass substrate such as glass substrate 108 (labeled “GLASS”) is shown in FIG. 12. As shown in FIG. 12, a polarizer film exhibits strong absorption in the ultraviolet (UV) range and in the visible range, whereas glass exhibits relatively low absorption in the visible range. Visible light is therefore a good candidate for polarizer trimming, as the differential between polarizer absorption and glass absorption is high in the visible range. For example, light of wavelength λ_{D} (e.g., a wavelength of approximately 532 nanometers) is strongly absorbed by polarizer films but is minimally absorbed by glass. Wavelength λ_{D} is therefore a good candidate for laser 160 to be used in polarizer trimming operations. Other suitable wavelengths that provide effective polarizer cuts without damaging glass 108 are wavelengths between 300 and 400 nanometers, 400 and 500 nanometers, 500 and 600 nanometers, 600 and 700 nanometers, 700 and 800 nanometers, 800 and 900 nanometers, 900 and 1000 nanometers, 1000 and 1100 nanometers, other suitable wavelengths, etc. Using a wavelength in the visible range such as a wavelength of 532 nanometers (e.g., wavelengths corresponding to green light) is merely an illustrative example.

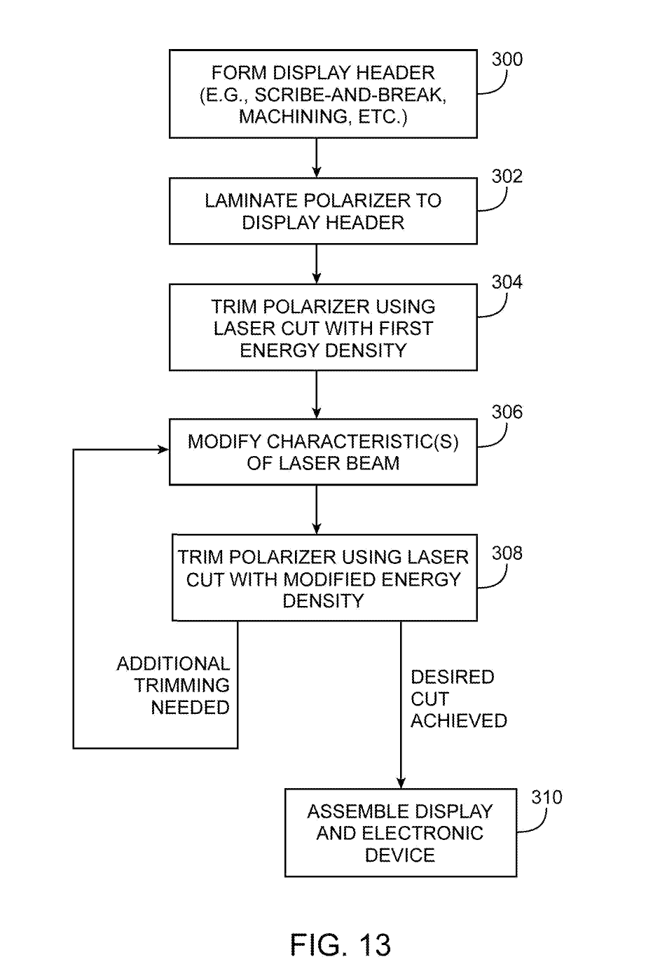

FIG. 13 is a flow chart of illustrative steps involved in forming display 14 and electronic device 10. As shown in FIG. 13, display layers such as display layer 108 (e.g., a color filter substrate for color filter layer 56 for display layers 46 in display 14 of FIG. 5) may be formed at step 300. The formation of display layer 108 may involve scribing and breaking glass layers such as layer 100 to form glass layers such as glass layer 108. Edges 110 of glass layer 108 may be machined using equipment 124.

At step 302, polarizer layer 54 is attached to the upper surface of glass layer 108 using lamination equipment 138 of FIG. 8.

At step 304, laser-based trimming techniques are used to trim excess polarizer that overhang the edges of glass layer 108. A laser beam scanning system is used to make laser cuts with high energy density along the edge of polarizer 54. The energy density of the laser cuts used during step 304 to trim polarizer 54 is sufficiently high for “coarse” trimming operations in which portions at the outermost periphery of polarizer film 54 are removed. Following the trimming operations of step 304, there may be a small amount of excess polarizer film hanging over the edge of glass layer 108.

At step 306, one or more characteristics of laser beam 162 are modified prior to performing additional polarizer trimming operations. In one suitable arrangement, the optical structures within laser 160 such as lens 176 are modified to produce a laser beam of increased spot size. Other components and/or settings that may be changed during step 306 to reduce the energy density of a subsequent laser cut include the optical power output (e.g., the average power output in the case of a pulsed or modulated laser or the continuous power output in the case of a continuous wave laser) of laser 160, the type of laser 160 used in system 150 (e.g., gas laser, solid-state laser, dye laser, semiconductor laser, or other suitable type of laser), the wavelength of light emitted by laser 160 (e.g., wavelengths in the ultraviolet range, wavelengths in the visible range, wavelengths in the infrared range, etc.), the pulse duration and/or pulse frequency of laser 160 (in arrangements where laser 160 is a pulsed laser), the position of laser 160 relative to polarizer 54 and/or substrate 108, the current applied to laser 160, other suitable components and settings, etc.

At step 308, the laser beam scanning system makes laser cuts with less energy density than the energy density of the laser cuts of step 304. The reduced energy density helps prevent damage to glass 108 during polarizer trimming operations as laser beam 162 approaches the surface of glass layer 108.

If desired, additional modifications can be made to laser beam 162 as laser beam 162 approaches the surface of glass layer 108. With each modification, additional laser scans are made to trim edge portions of polarizer 54. One, two, three, four, or more than four modifications to laser beam 162 can be made during the multiple-scan polarizer trimming process.

When the desired polarizer cut is achieved (e.g., when the lateral dimensions of polarizer 54 match the lateral dimensions of glass layer 108), processing proceeds to step 310. Substrate 108 may form a liquid crystal display color filter layer substrate for color filter layer 56 of display 14 of FIG. 5. At step 310, the layers of display 14 may be assembled to form display 14 of FIG. 5 and display 14 may be installed in device housing 12 of electronic device 10 with other device components.

The foregoing is merely illustrative and various modifications can be made by those skilled in the art without departing from the scope and spirit of the described embodiments. The foregoing embodiments may be implemented individually or in any combination.

What is claimed is:

1. A method of trimming a polarizer layer on a glass layer, comprising:
making a first laser light cut with a first energy density along an edge of the polarizer layer; and
after making the first laser light cut, making a second laser light cut with a second energy density that is less than the first energy density along the edge of the polarizer layer.

2. The method defined in claim 1 further comprising reducing the first energy density to the second energy density by enlarging a laser beam diameter associated with the laser.

3. The method defined in claim 1 further comprising reducing the first energy density to the second energy density by altering a lens structure associated with the laser.

4. The method defined in claim 1 wherein making the first laser light cut comprises making the first laser light cut using a laser, the method further comprising reducing the first energy density to the second energy density by reducing an optical power output of the laser.

5. The method defined in claim 1 wherein making the first laser light cut comprises making the first laser light cut using a pulsed laser having a pulse duration of 500 femtoseconds to 200 nanoseconds.

6. The method defined in claim 1 wherein making the first laser light cut comprises making the first laser light cut using visible laser light to trim the polarizer layer without damaging the glass display layer.

7. A method of trimming a layer of polarizer on a glass display layer using a scanning laser beam system, comprising:
making a plurality of scans with a moving laser beam along an edge of the polarizer to trim off a peripheral portion of the polarizer in alignment with an edge of the glass display layer.

8. The method defined in claim 7 further comprising:
modifying at least one characteristic of the moving laser beam between successive scans.

9. The method defined in claim 8 wherein the moving laser beam is characterized by a spot size on the polarizer and wherein modifying the at least one characteristic of the moving laser beam comprises adjusting the spot size between successive scans.

10. The method defined in claim 8 wherein the moving laser beam is characterized by a power and wherein modifying the at least one characteristic of the moving laser beam comprises adjusting the power between successive scans.

11. The method defined in claim 8 wherein the moving laser beam is characterized by a scan speed relative to the polarizer and wherein modifying the at least one characteristic of the moving laser beam comprises adjusting the scan speed between successive scans.

12. The method defined in claim 8 wherein the moving laser beam is characterized by a beam diameter and wherein modifying the at least one characteristic of the moving laser beam comprises adjusting the beam diameter between successive scans.

13. The method defined in claim 9 wherein modifying the at least one characteristic of the moving laser beam comprises adjusting a focusing lens associated with the moving laser beam between successive scans.

14. The method defined in claim 9 wherein modifying the at least one characteristic of the moving laser beam comprises modifying the at least one characteristic of the moving laser beam based on a distance between the moving laser beam to the edge of the glass display layer.

15. The method defined in claim 9 wherein modifying the at least one characteristic of the moving laser beam comprises reducing a power density of the moving laser beam between successive scans.

16. Apparatus for trimming edge portions of a polarizer film that overhang a glass display layer, comprising:
a visible light laser that produces a visible light laser beam; and
a laser beam scanning system that scans a focused spot of the visible light laser beam along an edge of the polarizer.

17. The apparatus defined in claim 16 wherein the visible light laser comprises a solid state laser.

18. The apparatus defined in claim 16 wherein the visible light laser is a pulsed laser having a pulse duration of 1 femtosecond to 100 nanoseconds.

19. The apparatus defined in claim 16 wherein the visible light laser beam has a wavelength of approximately 532 nanometers.

20. The apparatus defined in claim 16 wherein the glass display layer is a color filter substrate layer.
